(19) United States
(12) Patent Application Publication
(10) Pub. No.: US 2008/0259368 A1
(43) Pub. Date: Oct. 23, 2008

(54) Printer, Printing program, and printing method

(75) Inventor: Hiroaki Sakai, Chino-shi (JP)

Correspondence Address: Edwards Angell Palmer & Dodge LLP, P.O. Box 55874, Boston, MA, 02205, US

(73) Assignee: Seiko Epson Corporation, Tokyo (JP)

(21) Appl. No.: 12/072,474

(22) Filed: Feb. 25, 2008

(30) Foreign Application Priority Data
Feb. 23, 2007 (JP) 2007-043398

(51) Int. Cl. G06F 15/00

(52) U.S. Cl. 358/1.9

(57) ABSTRACT

A printer includes a print head in which nozzles that form an image by discharging ink are arranged in a plurality of lines. The printer prints out an image on the basis of print form data in which information of layout contents of printing elements that form the content of print is set according to the attribute of each printing element. The printer includes a print form data storage unit, a printing element data storage unit, a print form data selection unit, a printing element data selection unit, and a printing element data insertion unit. The print form data selection unit selects a piece of print form data, which is used for printing, from multiple pieces of print form data stored in the print form data storage unit in a specific sequence that is set so that, when the printing is continuously performed, the frequencies of use of the nozzles of the print head are uniform and are equal to or higher than a predetermined frequency.

### BACKGROUND

1. Technical Field

The present invention relates to a printer that prints out an image by discharging ink from nozzles, a printing program, and a printing method.

2. Related Art

For example, in an existing ink jet printer that prints out an image by discharging ink form nozzles, a process (which is called flushing, or the like) is performed to discharge ink from all the nozzles at a constant period of time during the printing process. In this manner, ink is prevented from clogging nozzles that are not used for printing. The above flushing technology is, for example, described as an ink jet recording apparatus in JP-A-2004-106470.

The ink jet recording apparatus described in JP-A-2004-106470 is provided with a head movement driving portion that reciprocally moves a line ink jet printer head, which performs a one-pass recording mode, in an array direction of its nozzles, that is, in a main scanning direction, and then executes a head movement process in which driving of the head movement driving portion is controlled to move the ink jet printer head in the array direction of the nozzles and a nozzle position modification process in which, in a direction opposite to the head movement direction at a pitch corresponding to the amount of shift of the ink jet printer head at this time, the positions of the nozzles, which discharge ink droplets, are shifted in the ink jet printer head as a whole. In this manner, the positions of the nozzles, which discharge ink droplets, are shifted in the ink jet printer head as a whole, so that nozzles that do not discharge ink are reduced, and, hence, it is less likely to cause an ink discharge defect in the nozzles.

However, in the existing art described in JP-A-2004-106470, an exclusive mechanism is required for shifting the nozzles, so that there is a possibility that inconvenience, such as an enlarged size of apparatus, may occur.

### SUMMARY

An advantage of some aspects of at least one embodiment of the invention is that it provides a printer, a printing program and a printing method, suitable for reducing ink clogging in nozzles that are not used during a printing process.

A first aspect of at least one embodiment of the invention provides a printer. The printer includes a print head in which nozzles that form an image by discharging ink are arranged in a plurality of lines. The printer prints out an image on the basis of print form data in which information of layout contents of printing elements that form the content of print is set according to the attribute of each printing element. The printer includes a print form data storage unit, a printing element data storage unit, a print form data selection unit, a printing element data selection unit, and a printing element data insertion unit. The print form data storage unit stores multiple pieces of print form data, which include different layout contents of printing elements, according to the content of usage. The printing element data storage unit stores multiple types of pieces of printing element data, which correspond to pieces of data of the printing elements, according to the attribute of each printing element. The print form data selection unit selects a piece of print form data, which is used for printing, from the multiple pieces of print form data stored in the print form data storage unit in a specific sequence that is set so that, when the printing is continuously performed, the frequencies of use of the nozzles of the print head are uniform and are equal to or higher than a predetermined frequency. The printing element data selection unit selects a piece of printing element data corresponding to each piece of information of layout content that is set in the selected piece of print form data from among the multiple types of pieces of printing element data stored in the printing element data storage unit. The printing element data insertion unit inserts the selected piece of printing element data into the selected piece of print form data on the basis of information of the print content, which is set in the selected piece of print form data.

According to the above configuration, when multiple media (for example, printing paper, or the like) are continuously printed, pieces of print form data are selected from among the multiple pieces of print form data, which include different layout contents of printing elements, in a specific sequence that is set so that the frequencies of use of the nozzles of the print head are uniform and are equal to or higher than a predetermined frequency, the pieces of printing element data each having an attribute corresponding to each layout content of the pieces of print form data that are selected in the specific sequence are inserted, and then printing may be performed. Therefore, when multiple media are continuously printed, nozzles of the print head may be used uniformly.

In this manner, it is advantageous in that, during a period when printing is continuously performed, as compared to the case where printing is performed using the same print form every time, it is possible to perform printing so that the number of nozzles that are not used is reliably reduced and all the nozzles are uniformly used. Thus, for example, when multiple sheets of documents having the same content of usage (purpose), such as direct mail, pay slip, or card history, are continuously printed, pieces of print form data, which include different layout contents of printing elements sheet by sheet, may be changed in a specific sequence by which the frequencies of use become uniform. Thus, it is advantageous in that clogging of ink of nozzles that are not used in printing process may be reliably reduced. Particularly, when the present aspect is applied to a printer that performs a flushing operation by which ink is discharged periodically from all the nozzles in order to prevent ink filled in the nozzles from getting dry, it is possible to reduce the number of flushing operations, the number of nozzles used for each flushing operation, or the like, without greatly changing the configuration of the printer. Furthermore, the number of flushing operations may be reduced in a printing process, so that it is possible to reduce a print speed in comparison with the existing printer. Particularly, the advantageous effects appear more remarkably as the number of prints increases.

Here, the print form data are data in which information of layout contents of printing elements that form the content of print is set according to the attribute of each printing element. The print form data include, for example, data that become templates of documents corresponding to the content of usage (purpose), such as direct mail or detailed statement, created using word processor software, or the like, data that become templates of arrangement of photographic images for printing images that are taken by a digital camera, or the like, in a predetermined layout, and the like. In addition, the print form data are formed to include information of a printing region and information of layout contents of pieces of printing element data, such as text data or image data, arranged in the printing region (for example, coordinates of layout positions (regions), conditions of layouts (character type, character size), and the like). Then, when printing is performed, a selected printing element is arranged (inserted) in each of the layout regions and printing is then performed. Thus, it is possible to easily create a document file or an image file according to the content of usage and then print out the file. Hereinafter, the same applies to a printing program of a seventh aspect and a printing method of an eighth aspect.

In addition, the information of layout content, for text data, corresponds to, for example, character size, character type, character spacing, margin, and the like, in addition to the coordinate information of the above described layout content. In addition, the information of layout content, for image data, corresponds to, for example, information of resolution, information of palette (limitations of color representation, and the like), information of type of algorithm when an image is reduced or enlarged to be adjusted to the size of a layout region, and the like, in addition to the above described coordinates of layout content, and the like. Hereinafter, the same applies to a printing program of a seventh aspect and a printing method of an eighth aspect.

In addition, the specific sequence is determined so that, for example, the frequencies of nozzle usage are obtained with respect to each of the pieces of print form data that are stored in the print form data storage unit, a combination of pieces of print form data, by which the frequencies of nozzle usage are uniform and are equal to or higher than a predetermined frequency in a predetermined period when printing is continuously performed, is determined on the basis of the frequencies of nozzle usage, and pieces of print form data are selected according to the combination. The predetermined frequency is preferably a frequency of use that does not cause clogging of ink. Hereinafter, the same applies to a printing program of a seventh aspect and a printing method of an eighth aspect.

In addition, the printing element data are data of printing elements that form the content of print, and include, for example, advertising copy and advertisement images for direct mail, or the like, table data in which the content of detailed statements, such as pay slips or card history, is written, image data, document data, table data according to the content of usage other than the above. Hereinafter, the same applies to a printing program of a seventh aspect and a printing method of an eighth aspect.

Furthermore, the printer according to a second aspect of at least one embodiment of the invention may be configured so that, in the printer of the first aspect, the print form data storage unit stores multiple pieces of print form data, which include different layout contents of the printing elements and which are grouped into a plurality of groups according to the content of usage, on the basis of the frequencies of use of the nozzles of the print head with respect to each of the pieces of print form data when printing is performed on the basis of the pieces of print form data, and the print form data selection unit selects groups from among the plurality of groups of the pieces of print form data, which are stored in the print form data storage unit, in a specific sequence that is set in advance so that, when the printing is continuously performed, the nozzles of the print head are uniformly used, and the piece of print form data used for printing is selected from the selected group of pieces of print form data.

According to the above configuration, when printing is continuously performed on the multiple media, groups of pieces of print form data are selected from the plurality of groups of pieces of print form data having different layout contents of the printing elements in a specific sequence that is set so that the frequencies of use of the nozzles of the print head are uniform and are equal to or higher than a predetermined frequency, and the pieces of print form data used for printing are selected from the groups of pieces of print form data that are selected in the specific sequence, the pieces of printing element data each having an attribute corresponding to each layout content of the selected pieces of print form data are inserted, and then printing may be performed. Therefore, when printing is continuously performed on multiple media, the nozzles of the print head may be uniformly used.

In this manner, it is advantageous in that, in a period when printing is continuously performed on the multiple media with the same content of usage, as compared to the case where printing is performed using the same print form every time, it is possible to perform printing in the above period so that the number of nozzles that are not used is reliably reduced and the nozzles are uniformly used.

Furthermore, the printer according to a third aspect of at least one embodiment of the invention may be configured so that, in the printer of the first or second aspect, the printing element data storage unit stores the multiple types of pieces of printing element data that are grouped into a plurality of groups according to the attribute of each printing element on the basis of the frequencies of use of the nozzles of the print head with respect to each of the pieces of printing element data when an image of the pieces of printing element data is printed, and the printing element data selection unit selects a group from among the plurality of groups of pieces of printing element data, which are stored in the printing element data storage unit, in a specific sequence that is set so that, when the printing is continuously performed, the frequencies of use of the nozzles of the print head are uniform, and selects the piece of printing element data corresponding to each piece of information of layout content that is set in the selected piece of print form data from among the selected group of pieces of printing element data.

According to the above configuration, in addition to the configuration that the piece of print form data is selected in the specific sequence, a group of pieces of printing element data is selected from among multiple types of groups of the pieces of printing element data in a specific sequence that is set so that the frequencies of use of the nozzles of the print head are uniform and are equal to or higher than a predetermined frequency, the piece of printing element data corresponding to each piece of layout content of the piece of print form data is selected from among the group of pieces of printing element data selected in the specific sequence, the selected piece of printing element data is inserted into the piece of print form data that is selected in the specific sequence, and then printing may be performed. Thus, when printing is continuously performed on multiple media, the nozzles of the print head may be further reliably uniformly used.

In this manner, it is advantageous in that, when printing is continuously performed on the multiple media with the same content of usage, as compared to the case where printing is performed using the same print form every time, it is possible to perform printing in the period when printing is continuously performed so that the number of nozzles that are not used is further reliably reduced and the nozzles are further uniformly used.

Furthermore, the printer according to a fourth aspect may be configured so that, in the printer of the third aspect, the print form data storage unit stores multiple pieces of print form data, which include different layout contents of the printing elements and which are grouped into groups of pieces of print form data corresponding to positions of distribution of the frequencies of use of the nozzles of the print head according to the content of usage on the basis of the positions of distribution with respect to each of the pieces of print form data when printing is performed on the basis of the print form data, the printing element data storage unit stores, on the basis of ink color of which the frequencies of use of the nozzles of the print head with respect to each piece of printing element data when images of the pieces of printing element data are printed become maximum, the multiple types of pieces of printing element data that are grouped according to the attribute of each printing element into groups of pieces of printing element data corresponding to ink colors of which the frequencies of use become maximum according to the attribute of each printing element, the print form data selection unit sequentially selects a group corresponding to the position of distribution one by one from among a plurality of groups of pieces of print form data that are formed of groups corresponding to the positions of distribution, and selects the piece of print form data, which is used for printing, from among the selected group of pieces of print form data, and the printing element data selection unit sequentially selects a group corresponding to each ink color one by one from among a plurality of groups of pieces of printing element data formed of groups corresponding to the ink colors of which the frequencies of use become maximum, and selects the piece of printing element data corresponding to the selected piece of print form data from the selected group of pieces of printing element data.

According to the above configuration, groups of pieces of print form data are formed according to the positions of distribution of the frequencies of use with respect to the nozzles used for printing an image of the piece of print form data (for example, the frequencies of use are high to the left, the frequencies of use are high at the center, the frequencies of use are high to the right, uniformity, or the like), and the group corresponding to the position of distribution may be sequentially selected one by one from these groups. In addition, a group of pieces of printing element data is formed according to ink colors of which the frequencies of nozzle usage become maximum, and the group corresponding to the ink color may be sequentially selected one by one from these groups.

In this manner, for example, it is advantageous in that, when printing is continuously performed on the multiple media, the groups of pieces of print form data having different positions of distribution may be sequentially selected medium by medium, and the pieces of printing element data having different maximum ink colors may be sequentially selected medium by medium, so that printing may be performed so that the frequencies of use of the nozzles corresponding to ink colors are uniform over all the nozzles.

Furthermore, the printer according to a fifth aspect may be configured so that, in the printer of any one of the second to fourth aspects, the print form data selection unit randomly selects a piece of print form data, which is used for printing, from among the selected group of pieces of print form data. According to the above configuration, because a piece of print form data used for printing may be randomly selected from the selected group of pieces of print form data, when the pieces of print form data in the same group are continuously used, it is advantageous in that it is possible to reduce probability by which the same pieces of print form data are continuously selected, and it is possible to absorb a variation in frequencies of nozzle usage in each group.

Furthermore, the printer according to a sixth aspect may be configured so that, in the printer of any one of the second to fifth aspects, the printing element data selection unit randomly selects a piece of printing element data corresponding to the selected piece of print form data from the selected group of pieces of printing element data. According to the above configuration, because a piece of printing element data corresponding to each piece of information of layout content of the selected target may be randomly selected from the selected group of pieces of printing element data, when the pieces of printing element data in the same group are continuously used, it is advantageous in that it is possible to reduce probability by which the same pieces of printing element data are continuously selected, and it is possible to absorb a variation in frequencies of nozzle usage in each group.

In the meantime, a seventh aspect of at least one embodiment of the invention provides a printing program. The printing program is used to control a printer. The printer includes a print head in which nozzles that form an image by discharging ink are arranged in a plurality of lines. The printer prints out an image on the basis of print form data in which information of layout contents of printing elements that form the content of print is set according to the attribute of each printing element. The printing program is used to execute a process on a computer. The process includes selecting a piece of print form data, which is used for printing, from among multiple pieces of print form data, which are stored in a print form data storage unit that stores the multiple pieces of print form data having different layout contents of the printing elements according to the content of usage, in a specific sequence that is set so that, when the printing is continuously performed, the frequencies of use of the nozzles of the print head are uniform and are equal to or higher than a predetermined frequency, selecting a piece of printing element data corresponding to each piece of information of layout content that is set in the selected piece of print form data from among multiple types of pieces of printing element data that are stored in a printing element data storage unit that stores the multiple types of pieces of printing element data, which are data of the printing elements, according to the attribute of each printing element, and inserting the selected piece of printing element data into the selected piece of print form data on the basis of information of the content of print, which is set in the selected piece of print form data.

With this configuration, when the program is read by the computer and, in accordance with the read program, the computer executes a process, the same function and advantageous effects as in the case of the printer of the first aspect are obtained. Almost all printers, such as ink jet printers, which are now commercially available, are provided with a computer system formed by a central processing unit (CPU), a storage device (RAM, ROM), an input/output device, or the like, and are able to implement the above described units using the computer system through software, so that it is possible to economically and easily implement the units in comparison with a case where the above units are implemented by creating an exclusive hardware.

Furthermore, by rewriting a portion of the program, it is possible to easily upgrade the software for function modifications and/or improvements. Note that the above aspect may be configured so that the functions implemented by the units of the above second aspect to sixth aspect are described as a program to be executed on the computer.

### Eighth Aspect

Furthermore, an eighth aspect of at least one embodiment of the invention provides a printing method. The printing method is used to control a printer. The printer includes a print head in which nozzles that form an image by discharging ink are arranged in a plurality of lines. The printer prints out an image on the basis of print form data in which information of layout contents of printing elements that form the content of print is set according to the attribute of each printing element. The printing method includes selecting a piece of print form data, which is used for printing, from among multiple pieces of print form data, which are stored in a print form data storage unit that stores the multiple pieces of print form data having different layout contents of the printing elements according to the content of usage, in a specific sequence that is set so that, when the printing is continuously performed, the frequencies of use of the nozzles of the print head are uniform and are equal to or higher than a predetermined frequency, selecting a piece of printing element data corresponding to each piece of information of layout content that is set in the selected piece of print form data from among multiple types of pieces of printing element data that are stored in a printing element data storage unit that stores the multiple types of pieces of printing element data, which are data of the printing elements, according to the attribute of each printing element, and inserting the selected piece of printing element data into the selected piece of print form data on the basis of information of the content of print, which is set in the selected piece of print form data.

In this manner, the same function and advantageous effects as in the case of the printer of the first aspect are obtained. Note that the above aspect may be configured so that the units of the above second to sixth aspects are replaced by steps.

### BRIEF DESCRIPTION OF THE DRAWINGS

The invention will be described with reference to the accompanying drawings, wherein like numbers reference like elements.

FIG. 1 is a block diagram that shows the configuration of a printer according to an embodiment of the invention.

FIG. 2 is a partially enlarged bottom view that shows the structure of a print head.

FIG. 3 is a block diagram that shows the hardware configuration of the printer.

FIG. 4 is a flowchart that shows a printing process executed in the printer.

FIG. 5 is a view that shows a first example of the size of a character region and the size of image regions when a piece of print form data is divided into three regions.

FIG. 6 is a view that shows a second example of the size of character regions and the size of image regions when a piece of print form data is divided into three regions.

FIG. 7 is a view that shows pieces of print form data (example 1 to example 8).

FIG. 8 is a view that shows the comparison results between a score of each region, defined in each of the pieces of print form data shown in FIG. 7, and a threshold value.

FIG. 9A is a view that shows a group configuration when grouping is performed with respect to CMYK, and FIG. 9B is a view that shows a group configuration when CMYK are separated into CMY and K and grouping is performed separately with respect to each of CMY and K.

FIG. 10A to FIG. 10D are views, each of which shows an example of a printing element.

FIG. 11A is a view that shows the relationship between a piece of printing element data corresponding to an image region and the frequencies of use of nozzles corresponding to each ink color, and FIG. 11B is a view that shows a group configuration of pieces of printing element data corresponding to an image region when grouping is performed on the basis of the relationship of FIG. 11A.

FIG. 12 is a flowchart that shows a process to select groups of pieces of print form data.

FIG. 13 is a flowchart that shows a process to select groups of pieces of printing element data.

FIG. 14 is a view that shows, a first example of a printing result when pieces of print form data are selected in a specific sequence.

FIG. 15 is a view that shows a second example of a printing result when pieces of print form data are selected in a specific sequence.

### DESCRIPTION OF EXEMPLARY EMBODIMENTS

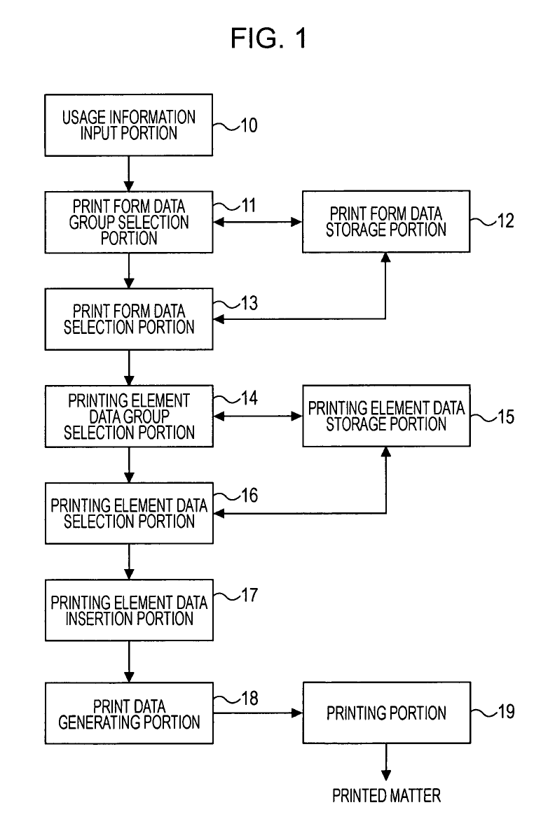

Hereinafter, an embodiment of the invention will be described with reference to the accompanying drawings. FIG. 1 to FIG. 15 are views that show an embodiment of a printer, a printing program and a printing method according to the invention. First, the configuration of the printer according to the embodiment of the invention will be described with reference to FIG. 1. FIG. 1 is a block diagram that shows the configuration of the printer 100 according to the embodiment of the invention. As shown in FIG. 1, the printer 100 includes a usage information input portion 10, a print form data group selection portion 11, a print form data storage portion 12, a print form data selection portion 13, a printing element data group selection portion 14, a printing element data storage portion 15, and a printing element data selection portion 16. The usage information input portion 10 inputs usage information that indicates the usage of a printed matter. The print form data group selection portion 11 selects groups of pieces of print form data corresponding to the content of usage from the print form data storage portion 12, which will be described later, in a specific sequence. The print form data storage portion 12 stores multiple types of pieces of print form data that are grouped on the basis of the frequencies of nozzle usage according to the content of usage. The print form data selection portion 13 selects pieces of print form data, which are used for printing, from among the selected groups of pieces of print form data. The printing element data group selection portion 14 selects a group of pieces of printing element data corresponding to each piece of layout content information of the selected pieces of print form data from the printing element data storage portion 15, which will be described later, in a specific sequence. The printing element data storage portion 15 stores multiple types of pieces of printing element data that are grouped on the basis of the frequencies of nozzle usage according to the attribute. The printing element data selection portion 16 selects pieces of printing element data, which will be inserted, from among the selected groups of pieces of printing element data.

The usage information input portion 10 has a function of inputting usage information, which is input by a user through an input device (not shown), into the print form data selection portion 13. The usage information may be, for example, information corresponding to the content of usage of a printed matter, such as direct mail, pay slip, or card history. Note that, in the present embodiment, the content of usage is input in such a manner that a list of selectable contents of usage is displayed in advance, a user is allowed to select any one of the contents of usage from among the contents of usage displayed in the list through an input device 74, which will be described later, and then the information of the selected content of usage is input.

The print form data group selection portion 11 has a function of selecting, on the basis of usage information that is input through the usage information input portion 10, groups of pieces of print form data corresponding to the usage information from the print form data storage portion 12 in a specific sequence that is set in advance. The above specific sequence is determined according to the content of usage on the basis of the frequencies of use of nozzles of a print head 200, which will be described later, corresponding to pieces of print form data that are stored in the print form data storage portion 12 and pieces of printing element data that are stored in the printing element data storage portion 15 so that the nozzles are uniformly used when printing is continuously performed on multiple sheets of paper. This specific sequence is also related to a process to select groups of pieces of printing element data, which will be described later. In the present embodiment, printing is performed so as to make uniform the frequencies of use of the nozzles in such a manner that groups of pieces of print form data are selected in the specific sequence and groups of pieces of printing element data are also selected in the specific sequence.

In addition, in the present embodiment, the above usage information includes information of the number of prints, and the print form data group selection portion 11, for example, when printing of ten copies is continuously performed with the same content of usage, selects groups of ten pieces of print form data corresponding to the ten copies (the same group may be overlappingly selected) in the above specific sequence. The print form data storage portion 12 has a function of storing multiple pieces of print form data that are grouped according to a position of distribution of the frequencies of nozzle usage corresponding to each piece of print form data according to the content of usage. Each piece of print form data differs from another piece of print form data in that the layout content of each printing element determined according to the content of usage. Thus, nozzles used for printing and the amount of usage of ink of each nozzle are different among the pieces of print form data.

In addition, the layout content information includes information of a layout position (coordinates) of each printing element, information of layout condition, and the like. For a region into which characters (text) and/or a table (ruled line and text) are inserted (hereinafter, termed as character region), the layout condition information includes font type, font size, character alignment (left alignment, right alignment, center alignment, or the like), line space, character spacing, and the like. In addition, for a region into which an image, such as an advertisement image or a photographic image, is inserted (hereinafter, termed as image region), the layout condition information includes information of resolution, information of palette (limitations of color representation, and the like), information of type of algorithm when an image is reduced or enlarged to be adjusted to the size of a layout region, and the like.

In addition, in regard to groups of pieces of print form data, serial numbers are assigned to the groups according to the content of usage of a printed matter, and, furthermore, in each group, serial numbers are assigned to pieces of print form data. Thus, the print form data storage portion 12 has a database configuration that uses these serial numbers as searching information. The print form data selection portion 13 has a function of selecting pieces of print form data, which are used for printing, in a predetermined sequence or randomly from among the groups selected by the print form data group selection portion 11 in accordance with a selection mode that is set in advance. That is, the print form data selection portion 13, in the present embodiment, has two modes as the selection mode: a sequential selection mode and a random selection mode.

The printing element data group selection portion 14 has a function of selecting groups of pieces of printing element data corresponding to the pieces of information of layout content on the basis of each piece of information of layout content of printing element that is set in each piece of print form data selected by the print form data selection portion 13 from the printing element data storage portion 15 in a specific sequence. The printing element data storage portion 15 has a function of storing multiple types of pieces of printing element data that are grouped according to the content of information regarding the frequencies of nozzle usage when an image of a piece of printing element data is printed according to the content of usage of a printed matter and also according to the attribute of each printing element, such as character or image.

Note that, in regard to the pieces of printing element data stored in the printing element data storage portion 15, serial numbers are assigned to groups of pieces of printing element data according to the content of usage of a printed matter and also according to the attribute of each printing element and, furthermore, in each group, serial numbers are assigned to pieces of printing element data. Thus, the printing element data storage portion 15 has a database configuration that uses these serial numbers as searching information. The printing element data selection portion 16 has a function of selecting pieces of printing element data corresponding to the pieces of layout content information from among the groups of pieces of printing element data that are selected by the printing element data group selection portion 14 in the selection mode that is set in the print form data selection portion 13. That is, in the print form data selection portion 13, when the sequential selection mode is set, pieces of printing element data will be selected in a predetermined sequence, and, when the random selection mode is set, pieces of printing element data will be selected randomly.

Furthermore, as shown in FIG. 1, the printer 100 further includes a printing element data insertion portion 17, a print data generating portion 18, and a printing portion 19. The printing element data insertion portion 17 inserts pieces of printing element data that are selected by the printing element data selection portion 16 into each piece of print form data selected by the print form data selection portion 13. The print data generating portion 18 generates print data using the pieces of print form data into which pieces of printing element data are inserted. The printing portion 19 prints out an image on the basis of the print data.

The printing element data insertion portion 17 has a function of inserting the pieces of printing element data that are selected by the printing element data selection portion 16 into the pieces of print form data that are selected by the print form data selection portion 13. Specifically, the printing element data insertion portion 17 inserts the pieces of printing element data, which are selected for pieces of layout content information, on the basis of information of layout position (coordinates) included in each piece of layout content information and information of layout condition included in each piece of layout content information. In this manner, pieces of print form data, for which pieces of printing element data are inserted into positions (regions) corresponding to pieces of layout position information, are formed.

The print data generating portion 18 has a function of generating print data to print out an image, formed of printing elements that are arranged at respective layout positions, on the basis of a piece of print form data into which pieces of printing element data are inserted by the printing element data insertion portion 17. Specifically, the print data generating portion 18 converts an image, formed of the printing elements, into data that indicate on/off of dots that will be formed by the print head 200, which will be described later, of the printing portion 19.

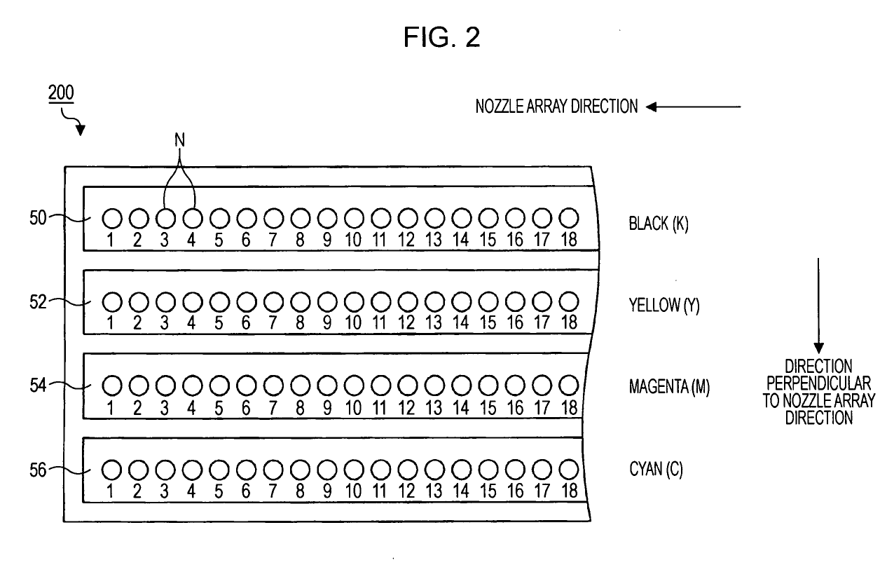

Here, the print head 200 applied to the embodiment of the invention will be described. FIG. 2 is a partially enlarged bottom view that shows the structure of the print head 200. As shown in FIG. 2, the print head 200 has a longitudinal structure extending in a paper width direction of print paper used in a so-called line head ink jet printer. The print head 200 is formed so that four nozzle modules 50, 52, 54, 56 are integrally arranged so as to form multi-lines and overlap in a print direction (a direction perpendicular to the nozzle array direction; strictly speaking, a dot print direction of nozzles). The black nozzle module 50 includes a plurality of nozzles N (eighteen in the drawing) that exclusively discharge black (K) ink and are arranged in a straight line. The yellow nozzle module 52 includes a plurality of nozzles N that exclusively discharge yellow (Y) ink and are arranged in a straight line along the same direction. The magenta nozzle module 54 includes a plurality of nozzles N that exclusively discharge magenta (M) ink and are arranged in a straight line along the same direction. The cyan nozzle module 56 includes a plurality of nozzles N that exclusively discharge cyan (C) ink and are arranged in a straight line along the same direction. Note that, when a print head is designed for monochrome printing, only a black (K) may be used, or, when a print head is designed for a high-quality image, six colors of ink or more that further includes light magenta, light cyan, or the like, may be used.

In addition, the above configured print head 200 prints circular dots on a white print sheet of paper by discharging ink, which is supplied into ink chambers (not shown) that are respectively provided for nozzles N1, N2, N3, . . . , through the nozzles N1, N2, N3, . . . , using piezoelectric elements, such as piezoactuators (not shown), which are provided for the respective ink chambers. Moreover, the print head 200 is able to print dots having different sizes for each nozzle N1, N2, N3, . . . , by adjusting the amount of ink discharged from the ink chambers by controlling electric voltage applied to the piezoelectric elements among multiple levels.

Here, the above described dot means a region formed by ink that is discharged from one or plurality of nozzles and is adhered on a printing medium. Moreover, an area of “dot” is not “zero”. The dot, of course, has a certain size (area) and, in addition, dots may have various sizes. However, dots formed by discharging ink do not always become a perfect circle. For example, when dots are formed in a shape other than perfect circle, such as ellipse, its average diameter is used as a dot diameter, or a perfect circle equivalent dot having the same area as an area of a dot formed by discharging a certain amount of ink is assumed and the diameter of the equivalent dot is used as a dot diameter.

Referring back to FIG. 1, the printing portion 19 is an ink jet printer such that a predetermined image is formed by a single scanning on a medium (hereinafter referred to as printing medium) used for printing by ejecting ink in a dot-like shape from the nozzle modules 50, 52, 54, 56, which are formed in the print head 200, while moving one of the medium (for example, print paper, or the like) used for printing or the print head 200 or both. In addition to the above described print head 200, the printing portion 19 further includes a paper feed mechanism (not shown) used for moving the printing medium, a print controller mechanism (not shown) that controls discharging of ink of the print head 200, and the like.

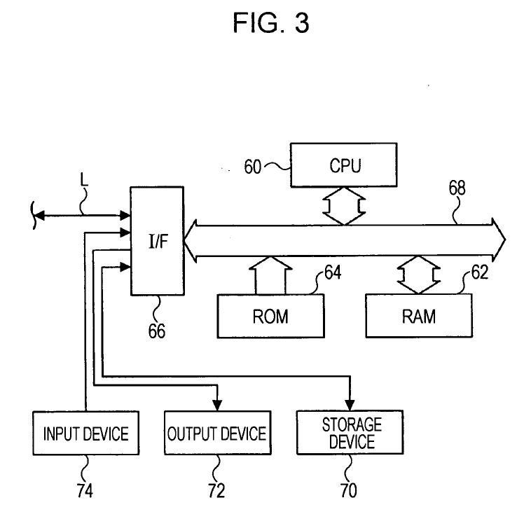

Note that, as described above, printing that is performed by inserting pieces of printing element data corresponding to pieces of layout content information into a piece of print form data, for which layout content information of each printing element that forms the content of print is set, is usually called variable printing. In addition, the printer 100 is provided with a computer system that implements the usage information input portion 10, the print form data selection portion 13, the printing element data selection portion 16, the printing element data insertion portion 17, the print data generating portion 18, the printing portion 19, and the like, on the computer software. The hardware configuration of the printer 100, as shown in FIG. 3, connects, using various internal and external buses 68 formed of a PCI (Peripheral Component Interconnect) bus, and the like, a CPU (Central Processing Unit) 60 that executes various controls and processes for printing, a RAM (Random Access Memory) 62 that constitutes a main storage device (Main Storage), a ROM (Read Only Memory) 64 that is a read only storage device, and connects a storage device (Secondary Storage) 70, such as HDD (Hard Disk Drive) that constitutes the print form data storage portion 12, the printing element data storage portion 15, and the like, an output device 72, such as the printing portion 19, a CRT, or an LCD monitor, the input device 74, such as the usage information input portion 10, an operation panel, a mouse, a keyboard, or a scanner, and a network L for communication with a print instruction device (not shown), or the like, to the buses 68 through an input/output interface (I/F) 66.

When the power is turned on, a system program of BIOS, or the like, stored in the ROM 64, or the like, loads various exclusive computer programs, which are stored in the ROM 64 in advance, onto the RAM 62. In accordance with the instructions described in the programs loaded onto the RAM 62, the CPU 60 uses various resources to execute a predetermined control and processing, thus implementing the above described functions through the software.

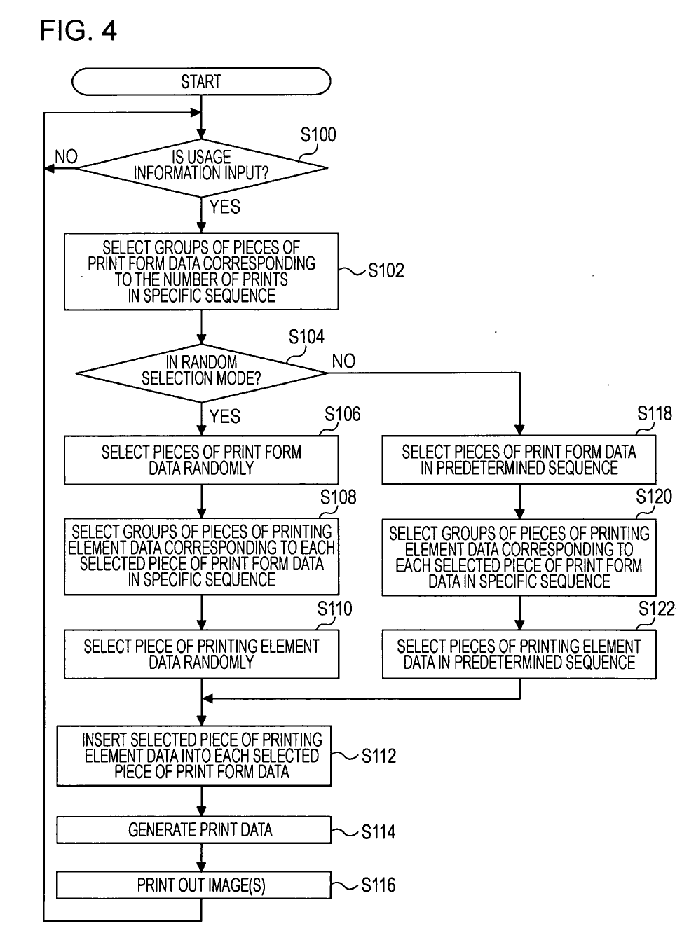

Next, the flow of a printing process in the above configured printer 100 will be described with reference to FIG. 4. Here, FIG. 4 is a flowchart that shows the printing process executed in the printer 100. The printing process, as shown in FIG. 4, first proceeds to step S100, and the usage information input portion 10 determines whether usage information is input from a print instruction terminal, or the like (not shown), such as a personal computer. When it is determined that usage information is input (Yes), the input usage information is output to the print form data group selection portion 11 and then the process proceeds to step S102. When a negative determination is made (No), the process repeats a determination process until usage information is input.

When the process proceeds to step S102, the print form data group selection portion 11 selects groups of pieces of print form data corresponding to the usage information that is input through the usage information input portion 10 from the print form data storage portion 12 in a specific sequence in accordance with the number of prints, and then the process proceeds to step S104. In step S104, the print form data selection portion 13 determines whether the random selection mode is set as a selection mode. When it is determined that the random selection mode is set (Yes), the process proceeds to step S106. When a negative determination is made (No), the process proceeds to step S118.

In step S106, the print form data selection portion 13 randomly selects a piece of print form data, used for printing, from among each of the groups of pieces of print form data that are selected in step S102 and the number of the selected groups corresponds to the number of prints, and then the process proceeds to step S108. In the present embodiment, the method to randomly select a piece of print form data employs a method in which a random number is generated using known linear congruential method, MT (Mersenne Twister) method, or the like, and a piece of print form data, of which a number assigned thereto in advance coincides with the generated random number, is selected. When a rate of generation is important, the former linear congruential method is used. When an accuracy of random number is important, the latter MT method is used.

In step S108, the printing element data group selection portion 14 selects a group of pieces of printing element data corresponding to each piece of the layout content information that is set in each piece of print form data selected in step S106 from the printing element data storage portion 15 in a specific sequence, and then the process proceeds to step S110. In step S110, the printing element data selection portion 16 randomly selects a piece of printing element data corresponding to each of pieces of layout content information from among each of the groups of the printing element data selected in step S108, and then the process proceeds to step S112.

In step S112, the printing element data insertion portion 17 inserts pieces of printing element data selected in step S110 or in step S122 into the corresponding pieces of print form data selected in step S106 on the basis of pieces of layout content information, and then the process proceeds to step S114. In step S114, the print data generating portion 18 generates print data on the basis of the pieces of print form data into which the pieces of printing element data are inserted in step S112, and then the process proceeds to step S116.

In step S116, the printing portion 19 prints out images, formed by the pieces of printing element data that are inserted in step S112, on the basis of the print data generated in step S114, after which a series of processes ends and the process proceeds to step S100.

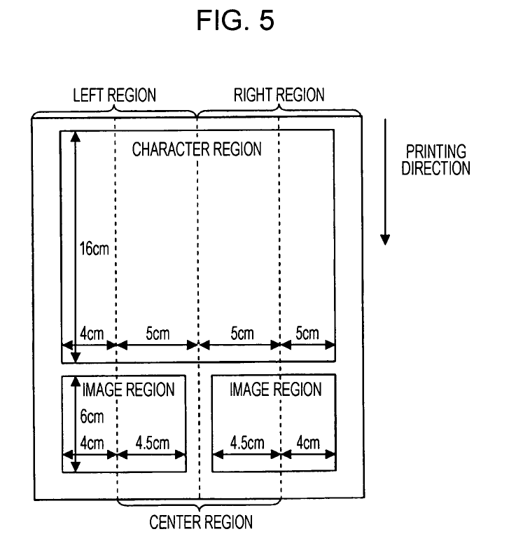

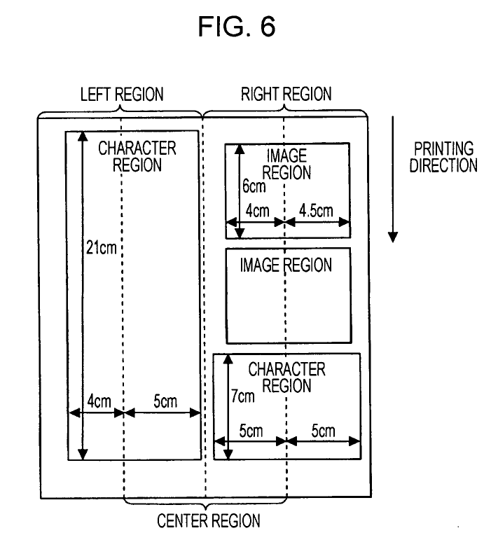

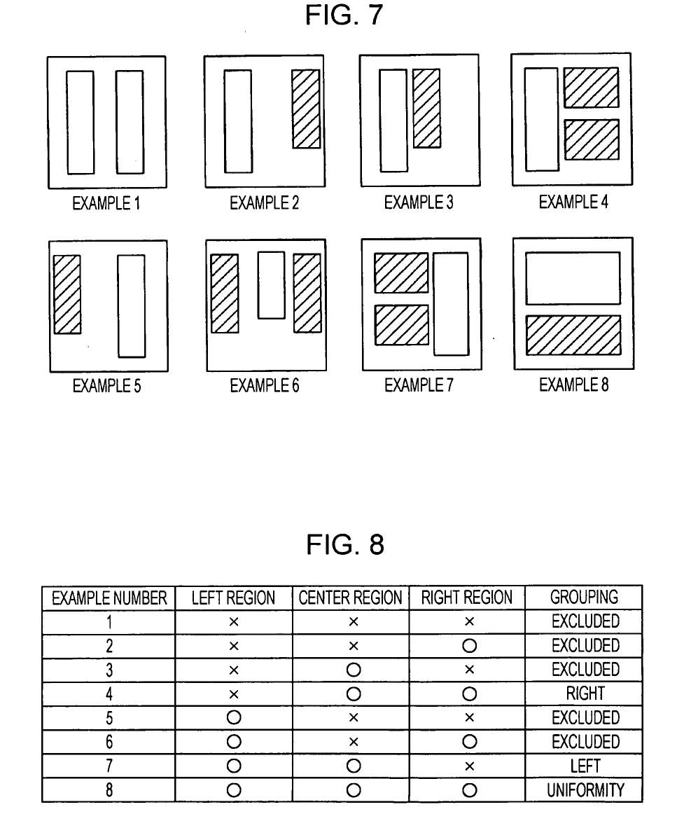

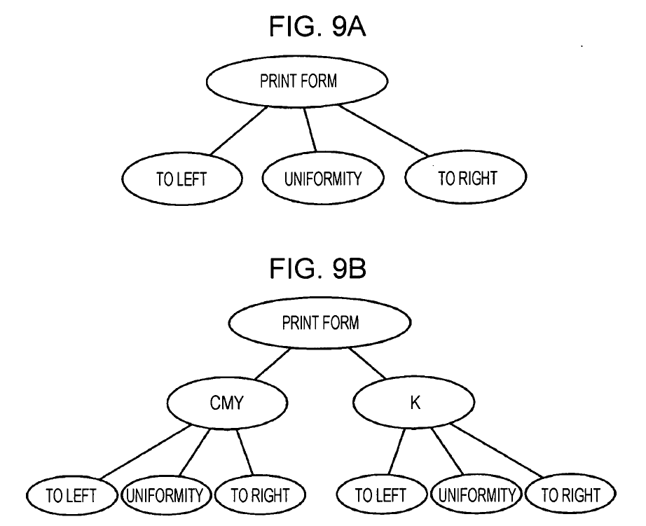

The operation of the present embodiment will now be described with reference to FIG. 5 to FIG. 15. First, grouping of pieces of print form data will be described with reference to FIG. 5 to FIG. 9B. FIG. 5 is a view that shows a first example of the size of a character region and the size of image regions when a piece of print form data is divided into three regions. FIG. 6 is a view that shows a second example of the size of character regions and the size of image regions when a piece of print form data is divided into three regions. FIG. 7 is a view that shows pieces of print form data (example 1 to example 8). FIG. 8 is a view that shows the comparison results between a score of each region, defined in each of the pieces of print form data shown in FIG. 7, and a threshold value. FIG. 9A is a view that shows a group configuration when grouping is performed with respect to CMYK, and FIG. 9B is a view that shows a group configuration when CMYK are separated into CMY and K and grouping is performed separately with respect to each of CMY and K.

In each of the pieces of print form data, pieces of printing element data for insertion are grouped into data that are inserted into a character region, which is an insertion region for a table image, a text sentence, or the like, and data that are inserted into an image region, which is an insertion region for an advertisement image, a photographic image, or the like. Normally, character images are often black and, therefore, the frequency of use of K ink increases in the character region. On the other hand, various colors are used in the image region, so that the frequencies of use of C, M, Y and K inks increase. Accordingly, through the presence or absence of a character region and an image region and the relationship of the arrangement between a character region and an image region in a print form, it is possible to estimate where the percentages of use of C, M, Y, and K inks are high or are low.

In addition, for example, the frequencies of use of C, M, Y, and K inks are high when a large number of advertisement images are printed, and the averages of the frequencies of use of colors are progressively uniform. On the contrary, in the case of text printing, the frequencies of use of C, M, and Y inks are low. Moreover, the dot density is high in the image region and low in the character region. When all the nozzles are used to print out an image of one sheet of paper (one page), it is possible to reduce clogging of nozzle. Furthermore, as the frequency of use of each nozzle increases, clogging of each nozzle may be further reduced.

That is, it is better to use the nozzles as much as possible and to increase the frequency of use of each nozzle when an image of one sheet of paper (one page) is printed. Specifically, as the number of dots used for printing in a direction perpendicular to a printing direction (nozzle array direction) is large, the frequency of use of each nozzle increases. Taking the above fact into consideration, for grouping pieces of print form data, first, a score is given to each image region and each character region that are set in a large number of pieces of print form data prepared in advance.

In the present embodiment, in association with dot density, each of the image regions is given a score of one point per a vertical length of 2 [cm] by a horizontal length of 1 [cm], and each of the character regions is given a score of one point per a vertical length of 8 [cm] by a horizontal length of 1 [cm]. Then, as shown by the dotted line in FIG. 5, an image forming region (printing region) is divided into quarters. By using two adjacent regions among the quartered regions, the image forming region is separated into three regions, which are a left region, a center region and a right region, as shown in FIG. 5.

For example, in the case of a print form (layout content) shown in FIG. 5, when the image forming region is divided into three regions and then a score is given to each of the regions as in the manner described above, the left region gets “(6÷2)×8.5+16÷8)×9=43.5 [points]”, the center region gets “(6÷2)×9+16÷8)×10=47 [points]”, and the right region gets “(6÷2)×8.5+16÷8)×10=43.5 [points]”. In addition, for example, in the case of a print form (layout content) shown in FIG. 6, when the image forming region is divided into three regions and then a score is given to each of the regions as in the manner described above, the left region gets “0+(21÷8)×9=23.625 [points], the center region gets “(6÷2)×4×2+(21÷8)×5+(7÷8)×5=41.5 [points], and the right region gets “(6÷2)×8.5×2+(7÷8)×5=55.375 [points].

As shown in the example of FIG. 6, the score of the left region in which the character region occupies a relatively large area is less than a half of the score of the right region in which the image region occupies a relatively large area. That is, in the case of printing that uses four color CMYK inks, because the character region substantially uses only K ink, the frequencies of nozzle usage with respect to CMYK ink colors are determined to be low (a score is set to be lower).

When a score is given to all of the pieces of print form data prepared in advance in accordance with the above manner, a distribution (deviation) of ink usage frequencies on each piece of print form data may be obtained. Specifically, by setting a threshold value, a determination is made by comparing the threshold value with the frequency of use of each region. For example, in printing that uses four color CMYK inks, the threshold value is set to 30 points and then is compared with the score of each region. In the first example shown in FIG. 5, because the scores of all of the regions are higher than 30 points, it is determined that the piece of print form data gives uniform frequencies of use in all the nozzles. In addition, in the second example shown in FIG. 6, because only the score of the left region is lower than 30 points, it is determined that the piece of print form data gives the frequencies of nozzle usage that are deviated to the right region.

In addition, in the case of printing that uses three color CMY inks, because C, M, and Y inks are also used to perform printing in the character region, in this case, the threshold value for scoring is, for example, set to 20 points. By decreasing the threshold value as compared to the case of four CMYK colors used as described above, because the scores of all the regions are larger than 20 points, for example, in the second example shown in FIG. 6, it is determined that the frequencies of nozzle usage on this piece of print form data are uniform in all the nozzles. By managing a distribution of the frequencies of nozzle usage using the scores as in the manner described above, even when CMY and K are separated, it is possible to manage the frequencies of nozzle usage in the same manner as the one that does not separate CMY from K.

Furthermore, FIG. 8 is a view that shows an example of the results for which the pieces of print form data of layout contents shown in the examples 1 to 8 in FIG. 7 are grouped in such a manner that a score is given to each region of each of the pieces of print form data and then a determination is made to each of the regions defined in each of the examples 1 to 8. In FIG. 8, the symbol “x” in the column of each region represents that the score of that region is lower than the threshold value, and the symbol “O” represents that the score of that region is equal to or higher than the threshold value. In addition, in the column of grouping, “RIGHT” indicates the group of which the frequencies of nozzle usage are deviated to the right region, “LEFT” indicates the group of which the frequencies of nozzle usage are deviated to the left region, and “UNIFORMITY” indicates the group of which the frequencies of nozzle usage are uniform over all the printing region.

In addition, “EXCLUDED” in the column of grouping indicates a piece of print form data, for which it is determined to be desirably excluded, because the ink usage frequencies are low over all the regions (the scores are smaller than the threshold value) or the ink usage frequencies of at least any one of the regions are extremely high or low. That is, because nozzles tend to be easily clogged when the ink usage frequencies are extremely low and also it is not preferable when the frequencies of use are extremely high, pieces of print form data of the above layout contents are excluded from the print form data storage portion 12.

The pieces of print form data that are grouped as shown in FIG. 8 are grouped into three groups, which are “TO LEFT”, “UNIFORMITY”, and “TO RIGHT”, as shown in FIG. 9A, according to a distribution of the frequencies of nozzle usage. The thus grouped pieces of print form data are stored in the print form data storage portion 12 according to the content of usage.

Note that the example shown in FIG. 9A shows an example of grouping when four color CMYK inks are grouped together; however, when three color CMY inks and K ink are separated, a group configuration will be the one shown in FIG. 9B. That is, as shown in FIG. 9B, pieces of print form data are grouped into two groups: a group corresponding to three color CMY inks and a group corresponding to K ink. Next, the group corresponding to three color CMY inks is grouped into three groups, which are “TO LEFT”, “UNIFORMITY”, and “TO RIGHT”, according to a distribution of the frequencies of nozzle usage. On the other hand, similarly, the group corresponding to K ink is grouped into three groups, which are “TO LEFT”, “UNIFORMITY”, and “TO RIGHT”, according to a distribution of the frequencies of nozzle usage.

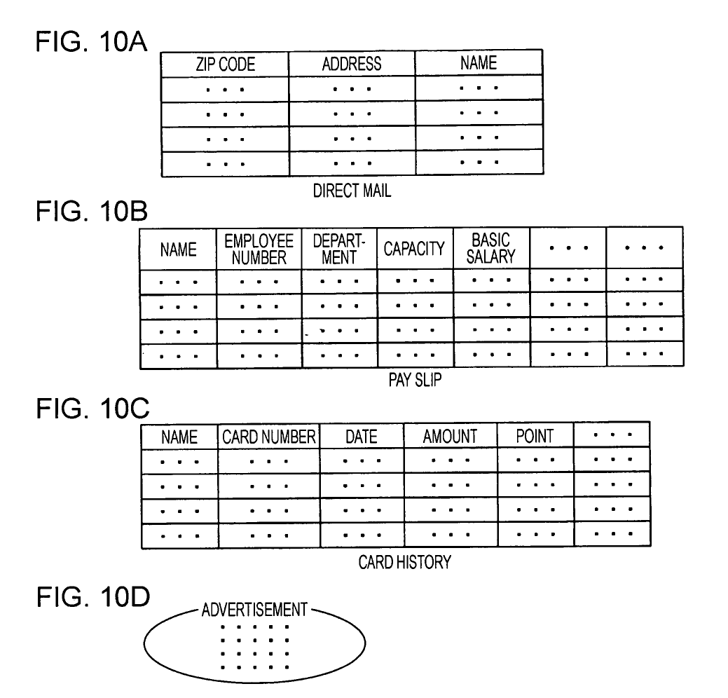

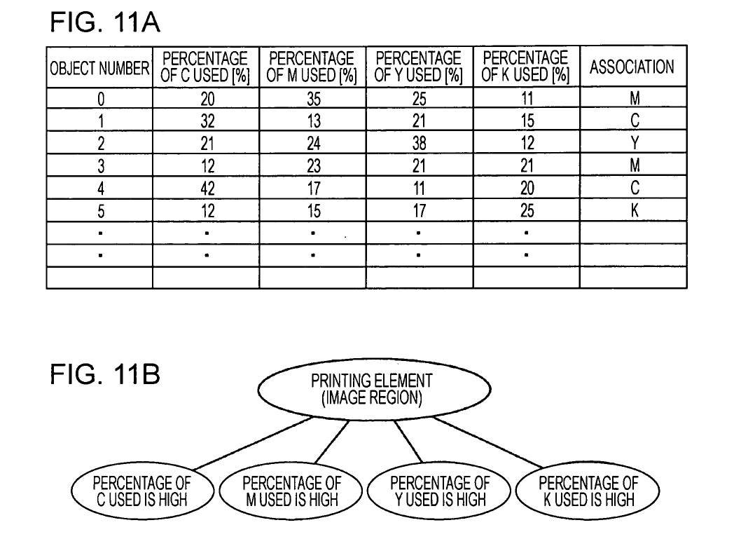

Note that all pieces of print form data are grouped according to the content of usage, and the example shown in FIG. 9A and the example shown in FIG. 9B each correspond to a piece of print form data of a certain content of usage. Next, grouping of pieces of printing element data corresponding to an image region will be described with reference to FIG. 10A to FIG. 11B. Here, FIG. 10A to FIG. 10D are views, each of which shows an example of a printing element. In addition, FIG. 11A is a view that shows the relationship between a piece of printing element data corresponding to an image region and the frequency of use of nozzles corresponding to each ink color, and FIG. 11B is a view that shows a group configuration of pieces of printing element data corresponding to an image region when grouping is performed on the basis of the relationship of FIG. 11A.

In the present embodiment, the printing element data storage portion 15 stores, for example, pieces of printing element data of table images (ruled line and text) shown in FIG. 10A to FIG. 10C, a piece of printing element data of an advertisement image shown in FIG. 10D, or the like. As described above, a piece of printing element data mainly made up of text, such as a table image, belongs to the character region, and a piece of printing element data made up of an image, such as an advertisement image, that does not include text belongs to the image region.

In the present embodiment, because printing is performed using four color CMYK inks, grouping is only performed over pieces of printing element data corresponding to the image region. First, in grouping pieces of printing element data (for example, advertisement image data shown in FIG. 10D, or the like) corresponding to the image region, the frequencies of use of nozzles corresponding to each color used to print out an image of each piece of printing element data are extracted and then the most frequently used ink color is associated with that piece of printing element data.

For example, when the print head used for printing is compatible with four CMYK ink colors, the percentage of C used, the percentage of M used, the percentage of Y used and the percentage of K used when an image of each piece of printing element data is printed are extracted as shown in FIG. 11A. Specifically, by obtaining projection information through color conversion of each piece of printing element data, the percentages of use of nozzles of ink colors corresponding to each piece of printing element data are extracted.

Then, as shown in the column of association shown in FIG. 11A, the most frequently used ink color is associated with a serial number (hereinafter, referred to as object number) that is associated with each piece of printing element data corresponding to the image region. In this manner, as shown in FIG. 11B, pieces of printing element data corresponding to the image region are grouped into four groups, which are “PERCENTAGE OF C USED IS HIGH”, “PERCENTAGE OF M USED IS HIGH”, “PERCENTAGE OF Y USED IS HIGH”, and “PERCENTAGE OF K USED IS HIGH”.

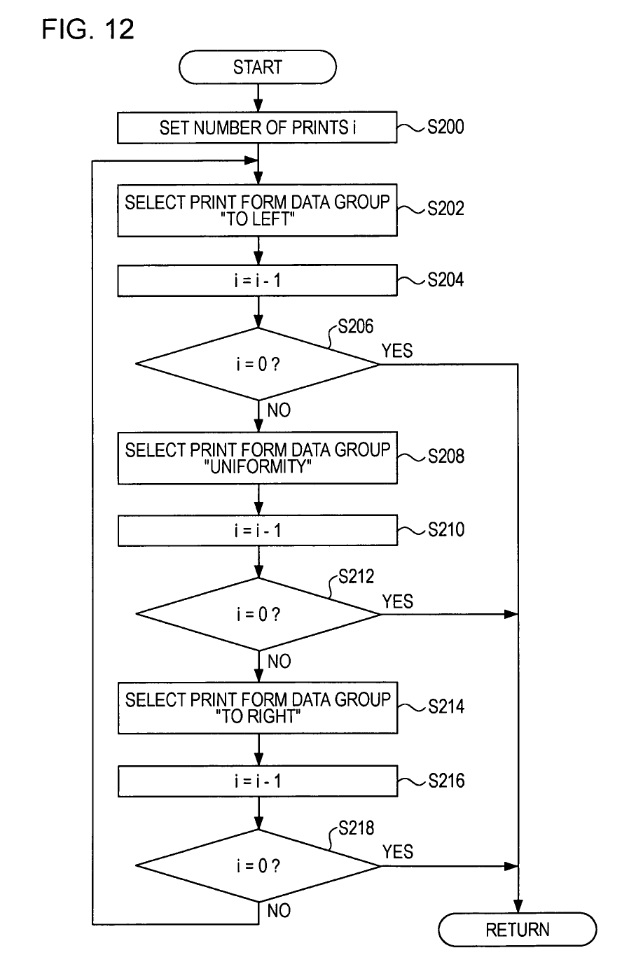

The thus grouped pieces of print form data are stored in the printing element data storage portion 15 according to the content of usage. Next, the operation of the printer 100 in a state where the pieces of print form data and the pieces of printing element data, which are grouped as described above, are respectively stored in the print form data storage portion 12 and the printing element data storage portion 15 will be described with reference to FIG. 12 to FIG. 15.

When usage information corresponding to a selection instruction from a print instruction device (not shown), or the like, is input, the usage information input portion 10, in the printer 100, outputs the input usage information to the print form data group selection portion 11 (“Yes” in step S100 in FIG. 4). Here, the usage information includes an instruction to print out ten copies of card history. In addition, an input determination process of usage information and an output process of input usage information are performed in such a manner that an exclusive program stored in the ROM 64 is loaded onto the RAM 62, and the loaded program is executed by the CPU 60.

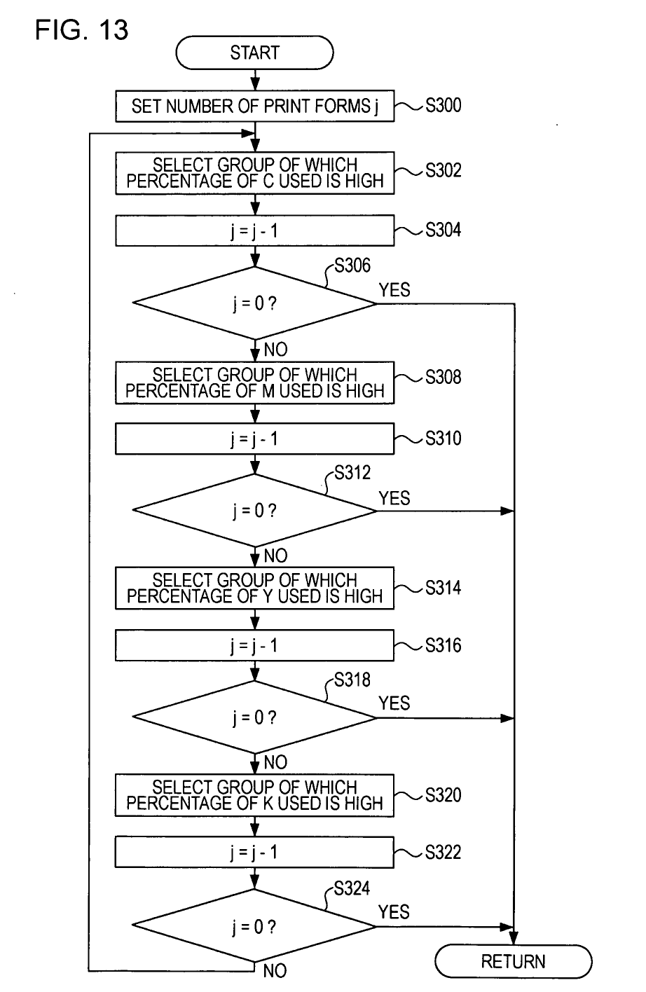

When the usage information is input from the usage information input portion 10, the print form data group selection portion 11 (see FIG. 13) selects groups of pieces of print form data corresponding to the usage information from the print form data storage portion 12 in a specific sequence (step S102 in FIG. 4). Note that the process to select groups of pieces of print form data is performed in such a manner that an exclusive program stored in the ROM 64 is loaded onto the RAM 62 and then the loaded program is executed by the CPU 60. Hereinafter, the process to select groups of pieces of print form data will be specifically described with reference to FIG. 12. Here, FIG. 12 is a flowchart that shows the process to select groups of pieces of print form data. The groups of pieces of print form data are, as described above, grouped into three groups, which are “TO LEFT”, “UNIFORMITY”, and “TO RIGHT”, according to the content of usage, so that the groups of “TO LEFT”, “UNIFORMITY”, and “TO RIGHT” are selected in a specific sequence.

First, on the basis of the number of prints included in the usage information, the value of a variable i that represents the number of prints is set (step S200). As described above, the number of prints is ten, so that it is set as “i=10”. As the number of prints has been set, the print form data group selection portion 11 first selects a group of pieces of print form data that belong to “TO LEFT” corresponding to the content of usage, and then outputs information of the selected group to the print form data selection portion 13 (step S202). When the group of “TO LEFT” has been selected, the value of i is decremented (i=i−1) (step S204). When the value of i, as a result, becomes “0” (“Yes” in step S206), it is determined that all the selection processes for the number of prints have been completed, after which a series of processes ends and the process proceeds to the original process.

Because the value of i is “9” at this time (“No” in step S206), a group of pieces of print form data that belong to “UNIFORMITY” and that correspond to the content of usage is subsequently selected, and information of the selected group is output to the print form data selection portion 13 (step S208). When the group of “UNIFORMITY” has been selected, the value of is decremented (i=i−1) (step S210). When the value of i, as a result, becomes “0” (“Yes” in step S212), it is determined that all the selection processes for the number of prints have been completed, after which a series of processes ends and the process proceeds to the original process.

Because the value of i is “8” at this time (“No” in step S212), a group of pieces of print form data that belong to “TO RIGHT” and that correspond to the content of usage is subsequently selected, and information of the selected group is output to the print form data selection portion 13 (step S214). When the group of “TO RIGHT” has been selected, the value of i is decremented (i=i−1) (step S216). When the value of i, as a result, becomes “0” (“Yes” in step S218), it is determined that all the selection processes for the number of prints have been completed, after which a series of processes ends and the process proceeds to the original process.

Because the value of i is “7”, at this time (“No” in step S218), a group of pieces of print form data that belong to “TO LEFT” and that correspond to the content of usage is subsequently selected, and information of the selected group is output to the print form data selection portion 13 (step S214). That is, until the value of i that represents the number of prints becomes “0”, the processes of step S202 to step S218 are repeated.

In this manner, when the number of prints is ten, groups of pieces of print form data are selected in a sequence of “TO LEFT”, “UNIFORMITY”, “TO RIGHT”, “TO LEFT”, “UNIFORMITY”, “TO RIGHT”, “TO LEFT”, “UNIFORMITY”, “TO RIGHT”, and “TO LEFT”. In the meantime, when information of the groups selected as described above is input, the print form data selection portion 13 selects pieces of print form data, which are used for printing, from among the selected groups of pieces of print form data that are stored in the print form data storage portion 12 in accordance with the selection mode that is set in advance.

Here, the random selection mode is set. In addition, each piece of print form data includes layout content information that includes layout condition information. Each piece of print form data is associated with searching information that includes information of usage content number, group number, specific form number, storage address of print form data, and is stored in the print form data storage portion 12. When the random selection mode is set (“Yes” in step S104 in FIG. 4), the print form data selection portion 13 first generates random numbers for selecting pieces of print form data by means of known MT method and searches the searching information of specific form numbers having the same numbers as the generated random numbers from among the selected groups of pieces of print form data.

Then, the print form data selection portion 13 reads out (selects) pieces of print form data stored in the addresses that are included in the search numbers retrieved through the above searching from the print form data storage portion 12 (step S106 in FIG. 4). Note that the process to select pieces of print form data (steps S104 and S106 in FIG. 4) is performed in such a manner that an exclusive program stored in the ROM 64 is loaded onto the RAM 62 and then the loaded program is executed by the CPU 60 (this also applies to step S118). When the pieces of print form data have been selected, the printing element data group selection portion 14 subsequently selects groups of pieces of printing element data corresponding to the pieces of layout content information that are set in the selected pieces of print form data from printing element data storage portion 15 in a specific sequence (step S108 in FIG. 4). Note that the process to select groups of pieces of printing element data is performed in such a manner that an exclusive program stored in the ROM 64 is loaded onto the RAM 62 and then the loaded program is executed by the CPU 60 (this also applies to step S120).

Hereinafter, the process to select groups of pieces of printing element data will be specifically described with reference to FIG. 13. Here, FIG. 13 is a flowchart that shows the process to select groups of pieces of printing element data. The groups of pieces of printing element data are, as described above, grouped, with respect to pieces of printing element data in the image region, into four groups, which are “PERCENTAGE OF C USED IS HIGH”, “PERCENTAGE OF M USED IS HIGH”, “PERCENTAGE OF Y USED IS HIGH”, and “PERCENTAGE OF K USED IS HIGH”, according to the content of usage, and the groups “PERCENTAGE OF C USED IS HIGH”, “PERCENTAGE OF M USED IS HIGH”, “PERCENTAGE OF Y USED IS HIGH”, and “PERCENTAGE OF K USED IS HIGH” are selected in a specific sequence.

First, on the basis of the number of prints included in the usage information, the value of a variable j that represents the number of print forms is set (step S300). As described above, the number of prints is ten, so that the number of print forms to be selected is also ten and, therefore, it is set as “j=10”. When the number of print forms has been set, the printing element data group selection portion 14 first selects a group of “PERCENTAGE OF C USED IS HIGH” as a group of pieces of printing element data that belong to the image region included in the first piece (TO LEFT) of print form data, and outputs information of the selected group and the first piece (TO LEFT) of print form data to the printing element data selection portion 16 (step S302). When the group of “PERCENTAGE OF C USED IS HIGH” has been selected, the value of j is decremented (j=j−1) (step S304). When the value of j, as a result, becomes “0” (“Yes” in step S306), it is determined that the selection processes to all the pieces of print form data have been completed, after which a series of processes ends and the process proceeds to the original process.

Because the value of j is “9” at this time (“No” in step S306), the printing element data group selection portion 14 subsequently selects a group of “PERCENTAGE OF M USED IS HIGH” as a group of pieces of printing element data that belong to the image region included in the second piece (UNIFORMITY) of print form data, and outputs information of the selected group and the second piece (UNIFORMITY) of print form data to the printing element data selection portion 16 (step S308). When the group of “PERCENTAGE OF M USED IS HIGH” has been selected, the value of j is decremented (j=j−1) (step S310). When the value of j, as a result, becomes “0” (“Yes” in step S312), it is determined that the selection processes to all the pieces of print form data have been completed, after which a series of processes ends and the process proceeds to the original process.

Because the value of j is “8” at this time (“No” in step S312), the printing element data group selection portion 14 subsequently selects a group of “PERCENTAGE OF Y USED IS HIGH” as a group of pieces of printing element data that belong to the image region included in the third piece (TO RIGHT) of print form data, and outputs information of the selected group and the third piece (TO RIGHT) of print form data to the printing element data selection portion 16 (step S314). When the group of “PERCENTAGE OF Y USED IS HIGH” has been selected, the value of j is decremented (j=j−1) (step S316). When the value of j, as a result, becomes “0” (“Yes” in step S318), it is determined that the selection processes to all the pieces of print form data have been completed, after which a series of processes ends and the process proceeds to the original process.

Because the value of j is “7” at this time (“No” in step S318), the printing element data group selection portion 14 subsequently selects a group of “PERCENTAGE OF K USED IS HIGH” as a group of pieces of printing element data that belong to the image region included in the fourth piece (TO LEFT) of print form data, and outputs information of the selected group and the fourth piece (TO LEFT) of print form data to the printing element data selection portion 16 (step S320). When the group of “PERCENTAGE OF K USED IS HIGH” has been selected, the value of j is decremented (j=j−1) (step S322). When the value of j, as a result, becomes “0” (“Yes” in step S324), it is determined that the selection processes to all the pieces of print form data have been completed, after which a series of processes ends and the process proceeds to the original process.

Because the value of j is “6”, at this time (“No” in step S324), the printing element data group selection portion 14 subsequently selects a group of “PERCENTAGE OF C USED IS HIGH” as a group of pieces of printing element data that belong to the image region included in the fifth piece (UNIFORMITY) of print form data, and outputs information of the selected group and the fifth piece (UNIFORMITY) of print form data to the printing element data selection portion 16 (step S302). That is, until the value of j that represents the number of pieces of print form data becomes “0”, the processes of step S302 to step S324 are repeated.

In this manner, when the number of prints is ten, a group of pieces of printing element data is selected in a sequence of “PERCENTAGE OF C USED IS HIGH”, “PERCENTAGE OF M USED IS HIGH”, “PERCENTAGE OF Y USED IS HIGH”, “PERCENTAGE OF K USED IS HIGH”, “PERCENTAGE OF C USED IS HIGH”, “PERCENTAGE OF M USED IS HIGH”, “PERCENTAGE OF Y USED IS HIGH”, “PERCENTAGE OF K USED IS HIGH”, “PERCENTAGE OF C USED IS HIGH”, and “PERCENTAGE OF M USED IS HIGH”. Because, for the ten prints, groups of pieces of print form data are selected in the above sequence and groups of pieces of printing element data are selected in the above sequence, the selection sequence that combines the above two sequences will be a sequence of “TO LEFT”, “PERCENTAGE OF C USED IS HIGH”, “UNIFORMITY”, “PERCENTAGE OF M USED IS HIGH”, “TO RIGHT”, “PERCENTAGE OF Y USED IS HIGH”, “TO LEFT”, “PERCENTAGE OF K USED IS HIGH”, “UNIFORMITY”, “PERCENTAGE OF C USED IS HIGH”, “TO RIGHT”, “PERCENTAGE OF M USED IS HIGH”, “TO LEFT”, “PERCENTAGE OF Y USED IS HIGH”, “UNIFORMITY”, “PERCENTAGE OF K USED IS HIGH”, “TO RIGHT”, “PERCENTAGE OF C USED IS HIGH”, “TO LEFT”, AND “PERCENTAGE OF M USED IS HIGH”.

In the meantime, when information of the groups of pieces of printing element data selected as described above and pieces of print form data corresponding to the selected groups of pieces of printing element data have been input to the printing element data selection portion 16, the printing element data selection portion 16 selects pieces of printing element data, which will be inserted into the pieces of print form data, from among the selected group of printing element data stored in the printing element data storage portion 15 in accordance with the same mode as the selection mode that is set in the print form data selection portion 13.

Here, because the random selection mode is set, first, random numbers are generated by means of known MT method in order to select pieces of printing element data from among the selected groups of pieces of printing element data, and the searching information of object numbers having the same numbers as the generated random numbers are searched from the selected groups of pieces of printing element data. Then, the printing element data selection portion 16 reads out (selects) pieces of printing element data corresponding to the object numbers that are retrieved through the above searching from the printing element data storage portion 15 (step S110 in FIG. 4). The read pieces of printing element data are output to the printing element data insertion portion 17 together with the pieces of print form data corresponding to the read pieces of printing element data.

On the other hand, in regard to the pieces of printing element data corresponding to the character region, the printing element data selection portion 16 generates random numbers by means of known MT method, searches pieces of printing element data having the same numbers as the random numbers from the printing element data storage portion 15 from among multiple types of pieces of printing element data corresponding to the content of usage of the print form data, and reads out (selects) the piece of printing element data retrieved through the above searching from the printing element data storage portion 15 (step S110 in FIG. 4). Note that the process to select pieces of print form data is performed in such a manner that an exclusive program stored in the ROM 64 is loaded onto the RAM 62 and then the loaded program is executed by the CPU 60 (this also applies to step S122).

Furthermore, when the set selection mode is the sequential selection mode (“No” in step S104 in FIG. 4), pieces of print form data are selected in a predetermined sequence when the pieces of print form data are selected from the selected groups of pieces of print form data in the specific sequence (step S118). Then, in the case of printing element data as well, groups of pieces of printing element data are selected in a specific sequence (step S120 in FIG. 4), and pieces of printing element data are selected from among the groups of pieces of printing element data, which are selected in the specific sequence, in a predetermined sequence (step S122 in FIG. 4). For example, the selection may be made in a sequence (descending sequence or ascending sequence) of serial numbers that are associated with pieces of print form data and pieces of printing element data.

As the pieces of printing element data corresponding to the selected piece of print form data have been selected, the printing element data insertion portion 17 subsequently inserts the selected pieces of printing element data into the selected piece of print form data on the basis of layout content information set for the piece of print form data (step S112 in FIG. 4). Note that the process to insert pieces of printing element data is performed in such a manner that an exclusive program stored in the ROM 64 is loaded onto the RAM 62 and then the loaded program is executed by the CPU 60 (this also applies to step S122). Specifically, into each character region and image region of layout positions indicated by the layout content information, pieces of printing element data that are selected in correspondence with these regions are inserted and thereby to form a piece of image data corresponding to one sheet of paper.

The print data generating portion 18 converts the print form data, to which the pieces of printing element data have been inserted, into data that represent the on/off state of a dot of each pixel to thereby generate print data of a format that may be interpreted by the printing portion 19 (step S114 in FIG. 4). Note that the process to generate print data is performed in such a manner that an exclusive program stored in the ROM 64 is loaded onto the RAM 62 and then the loaded program is executed by the CPU 60.

As the print data is generated, the printing portion 19 prints out an image formed of the inserted printing elements on a printing medium on the basis of the print data (step S116 in FIG. 4). Note that the printing process is performed in such a manner that an exclusive program stored in the ROM 64 is loaded onto the RAM 62, the loaded program is executed by the CPU 60, and then the output device 72 (the hardware of the printing portion 19, such as print head 200)) is controlled on the basis of print control signals from the CPU 60.

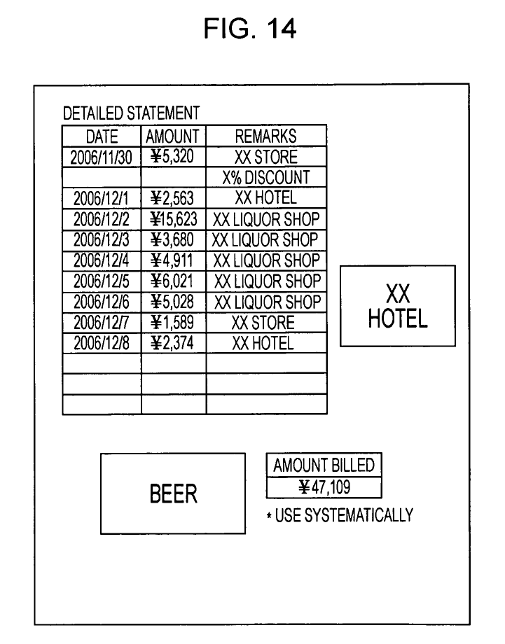

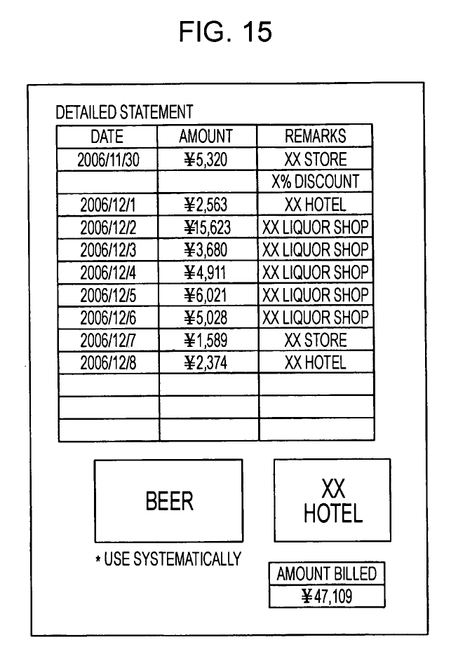

FIG. 14 and FIG. 15 are views that respectively show a first example and a second example of a printing result when pieces of print form data are selected in a specific sequence. The first piece of print form data is the one that is randomly selected from the “TO LEFT” group of pieces of print form data, so that, for example, as shown in FIG. 14, an image of a piece of print form data in which a table image of [symbol] and an advertisement image of [symbol] are arranged to the left is printed. In addition, in regard to the advertisement image [symbol] the percentage of C ink used is maximum.

In addition, the second piece of print form data is the one that is randomly selected from the “UNIFORMITY” group of pieces of print form data, so that, for example, as shown in FIG. 15, an image of a piece of print form data in which a table image of [symbol] with a wide range in a horizontal direction and advertisement images of [symbol] and [symbol] that are arranged next to each other in a row is printed. In addition, in regard to the advertisement images [symbol] and [symbol] the percentage of M ink used is maximum.

Here, the amount of ink discharged to prevent ink from clogging in nozzles will be described. Generally, a minimum standard amount of discharged ink required in order to prevent nozzle clogging is determined. This minimum standard is determined as a criterion in which m or more number of dots printed in n seconds is required. Thus, when printing on print paper is considered, it is not particularly necessary to make the number of dots printed per one sheet of printed result be m or above. For example, when the printer 100 can print p sheets per n seconds, it is only necessary for all the nozzles to print m or more number of dots per p sheets. Particularly, a line head printer, which completes printing by a single scanning, has a head arranged in a line above a sheet of paper in order to print out at high speed, so that multiple sheets of paper may be printed per one second. In addition, n seconds range from a few seconds to several tens of seconds, so that it is sufficient to perform printing of standard m or more number of dots in units of multiple sheets of paper.

That is, first, for a piece of print form data of which the frequencies of nozzle usage are deviated to the left, an image of a piece of print form data, into which a piece of printing element data that gives a large percentage of C ink used is inserted, is printed. Subsequently, for a piece of print form data of which the frequencies of nozzle usage are uniform, an image of a piece of print form data, into which a piece of printing element data that gives a large percentage of M ink used is inserted, is printed. After that, for a piece of print form data of which the frequencies of nozzle usage are deviated to the right, an image of a piece of print form data, into which a piece of printing element data that gives a large percentage of Y ink used is inserted, is printed. Thereafter, for a piece of print form data of which the frequencies of nozzle usage are deviated to the left, an image of a piece of print form data, into which a piece of printing element data that gives a large percentage of K ink used is inserted, is printed.

By repeating the printing process having the above described cycle for the number of prints, nozzles corresponding to CMYK ink colors are uniformly used, and it is possible to form numbers of dots (equal to or more than m) that are sufficient to prevent ink from clogging in nozzles. That is, during a period when printing is continuously performed, it is possible to perform printing in which almost all the nozzles of the print head 200 are uniformly used by an amount of use that is sufficient to prevent clogging of ink.

As described above, the printer 100 according to the present embodiment is able to select, using the print form data group selection portion 11, groups of pieces of print form data from multiple types of groups of pieces of print form data for which layout content information is set in advance with respect to the instructed number of prints according to the content of usage and that are grouped according to distribution information of nozzle usage frequencies in a specific sequence by which the frequencies of nozzle usage become uniform.

In addition, the printer 100 is able to select, using the print form data selection portion 13, pieces of print form data, used for printing, from the selected groups of pieces of print form data in accordance with the selection mode that is set in advance. Moreover, the printer 100 is able to select, using the printing element data group selection portion 14, groups of pieces of printing element data corresponding to the selected pieces of print form data from among the multiple types of groups of pieces of printing element data (image region) that are grouped in accordance with the frequencies of nozzle usage according to the content of usage in a specific sequence by which the frequencies of nozzle usage become uniform.

Furthermore, the printer 100 is able to select, using the printing element data selection portion 16, pieces of printing element data, which will be inserted into the pieces of print form data, from among the selected groups of pieces of printing element data in the same mode as the selection mode that is set in the print form data selection portion 13. Yet furthermore, the printer 100 is able to insert, using the printing element data insertion portion 17, the selected pieces of printing element data into the selected pieces of print form data, and then is able to generate, using the print data generating portion 18, print data from the pieces of print form data, into which the selected pieces of printing element data have been inserted. Then, the printer 100 is able to print out, using the printing portion 19, images on the basis of the print data.

Accordingly, when printing is continuously performed on multiple sheets of paper, groups of pieces of print form data and groups of pieces of printing element data are selected in a specific sequence by which the frequencies of nozzle usage become uniform, and images formed of the pieces of print form data and the pieces of printing element data that are included in the selected groups may be continuously printed in the specific sequence. Thus, it is possible to use the nozzles of the print head 200 uniformly and with an amount of use sufficient to prevent ink from getting dry (clogging of ink).

In the above described embodiment, the print form data group selection portion 11 and the print form data selection portion 13 may be regarded as the print form data selection unit of any one of the first, second, fourth and fifth aspects, the print form data storage portion 12 may be regarded as the print form data storage unit of any one of the first, second, fourth, seventh and eighth aspects, the printing element data group selection portion 14 and the printing element data selection portion 16 may be regarded as the printing element data selection unit of any one of the first, third and sixth aspects, the printing element data storage portion 15 may be regarded as the printing element data storage unit of any one of the first, third, fourth, seventh and eighth aspects, and the printing element data insertion portion 17 may be regarded as the printing element data insertion unit of the first aspect.

In addition, in the above embodiment, steps S102 to S106 and S118 may be regarded as the print form data selection step of the seventh or eighth aspect, the steps S108, S110, S120, and S122 may be regarded as the printing element data selection step of the seventh or eighth aspect, and the step S112 may be regarded as the printing element data insertion step of the seventh or eighth aspect. Note that, in the above embodiment, the pieces of print form data are grouped in accordance with a distribution (deviation) of the frequencies of nozzle usage; however, the grouping is not limited to it. The grouping may be performed according to a further segmented distribution, or may be performed by means of another method.

In addition, in the above embodiment, groups of pieces of print form data and groups of pieces of printing element data are respectively selected in a specific sequence shown by the flowchart in FIG. 12 and in a specific sequence shown by the flowchart in FIG. 13; however, the selection sequence is not limited to it. Any selection sequence is applicable when the selection sequence may be a sequence by which, when printing is continuously performed on multiple sheets of paper, the frequencies of use of nozzles of the print head 200 become uniform and are sufficient to prevent clogging of ink.

Moreover, the feature of the printer 100 according to the above embodiment is that it is possible to improve the frequencies of nozzle usage using the manner of selection of a piece of print form data and a piece of printing element data without substantially adding any additional components to the existing printer itself. Thus, it is not necessary to particularly provide an exclusive component as the printing portion 19, and it is possible to use the existing ink jet printer. Furthermore, when the printing portion 19 is separated from the printer 100 according to the above embodiment, the functions of the printing portion 19 may be implemented by a general purpose print instruction terminal, such as a personal computer, a printer server, or the like.

In addition, in the above embodiment, an exclusive computer program stored in the ROM 64 is loaded onto the RAM 62 to be executed by the CPU 60; however, the configuration is not limited to it. The programs may be installed in the storage device 70 through a storage medium, such as a CD-ROM, a DVD-ROM, a flexible disk (FD), or may be installed in the storage device 70 through a communication network, such as Internet and then loaded onto the RAM 62 to be executed by the CPU 60.

What is claimed is:

1. A printer that includes a print head in which nozzles that form an image by discharging ink are arranged in a plurality of lines, wherein the printer prints out an image on the basis of print form data in which information of layout contents of printing elements that form a content of a print is set according to an attribute of each printing element, comprising:
a print form data storage unit that stores multiple pieces of print form data, which include different layout contents of printing elements, according to a content of usage;
a printing element data storage unit that stores multiple types of pieces of printing element data, which correspond to pieces of data of the printing elements, according to the attribute of each printing element;
a print form data selection unit that selects a piece of print form data, which is used for printing, from the multiple pieces of print form data stored in the print form data storage unit in a specific sequence that is set so that, when the printing is continuously performed, the frequencies of use of the nozzles of the print head are uniform and are equal to or higher than a predetermined frequency;
a printing element data selection unit that selects a piece of printing element data corresponding to each piece of information of layout content that is set in the selected piece of print form data from among the multiple types of pieces of printing element data stored in the printing element data storage unit; and
a printing element data insertion unit that inserts the selected piece of printing element data into the selected piece of print form data on the basis of information of the content of print, which is set in the selected piece of print form data.

2. The printer according to claim 1, wherein
the print form data storage unit stores multiple pieces of print form data, which include different layout contents of the printing elements and which are grouped into a plurality of groups according to the content of usage, on the basis of frequencies of use of the nozzles of the print head with respect to each of the pieces of print form data when printing is performed on the basis of the piece of print form data, and
the print form data selection unit selects a group from among the plurality of groups of the pieces of print form data, which are stored in the print form data storage unit, in a specific sequence that is set in advance so that, when printing is continuously performed, the nozzles of the print head are uniformly used, and the piece of print form data used for printing is selected from the selected group of pieces of print form data.

3. The printer according to claim 1, wherein
the printing element data storage unit stores the multiple types of pieces of printing element data that are grouped into a plurality of groups according to the attribute of each printing element on the basis of the frequencies of use of the nozzles of the print head with respect to each of the pieces of printing element data when an image of the piece of printing element data is printed, and
the printing element data selection unit selects a group from among the plurality of groups of the pieces of printing element data, which are stored in the printing element data storage unit, in a specific sequence that is set so that, when the printing is continuously performed, the frequencies of use of the nozzles of the print head are uniform, and selects the piece of printing element data corresponding to each piece of information of layout content that is set in the selected piece of print form data from among the selected group of pieces of printing element data.

4. The printer according to claim 3, wherein
the print form data storage unit stores multiple pieces of print form data, which include different layout contents of the printing elements and which are grouped into groups of pieces of print form data corresponding to positions of distribution of the frequencies of use of the nozzles of the print head according to the content of usage on the basis of the positions of distribution with respect to each of the pieces of print form data when printing is performed on the basis of the print form data,
the printing element data storage unit stores, on the basis of ink color of which the frequencies of use of the nozzles of the print head with respect to each piece of printing element data when an image of the piece of printing element data is printed become maximum, the multiple types of pieces of printing element data that are grouped according to the attribute of each printing element into groups of pieces of printing element data corresponding to ink colors of which the frequencies of use become maximum according to the attribute of each printing element,
the print form data selection unit sequentially selects a group corresponding to the position of distribution one by one from among a plurality of groups of pieces of print form data that are formed of groups corresponding to the positions of distribution, and selects the piece of print form data, which is used for printing, from among the selected group of pieces of print form data, and
the printing element data selection unit sequentially selects a group corresponding to each ink color one by one from among a plurality of groups of pieces of printing element data formed of groups corresponding to the ink colors of which the frequencies of use become maximum, and selects the piece of printing element data corresponding to the selected piece of print form data from the selected group of pieces of printing element data.

5. The printer according to claim 2, wherein the print form data selection unit randomly selects a piece of print form data, which is used for printing, from among the selected group of pieces of print form data.

6. The printer according to claim 2, wherein the printing element data selection unit randomly selects a piece of printing element data corresponding to the selected piece of print form data from among the selected group of pieces of printing element data.

7. A printing program that is used to control a printer that includes a print head in which nozzles that form an image by discharging ink are arranged in a plurality of lines, wherein the printer prints out an image on the basis of print form data in which information of layout contents of printing elements that form the content of print is set according to the attribute of each printing element, wherein the printing program is used to execute a process on a computer, the process comprising:
selecting a piece of print form data, which is used for printing, from among multiple pieces of print form data, which are stored in a print form data storage unit that stores the multiple pieces of print form data having different layout contents of the printing elements according to the content of usage, in a specific sequence that is set so that, when the printing is continuously performed, the frequencies of use of the nozzles of the print head are uniform and are equal to or higher than a predetermined frequency;
selecting a piece of printing element data corresponding to each piece of information of layout content that is set in the selected piece of print form data from among multiple types of pieces of printing element data that are stored in a printing element data storage unit that stores the multiple types of pieces of printing element data, which are data of the printing elements, according to the attribute of each printing element; and
inserting the selected piece of printing element data into the selected piece of print form data on the basis of information of the content of print, which is set in the selected piece of print form data.

8. A printing method used to control a printer that includes a print head in which nozzles that form an image by discharging ink are arranged in a plurality of lines, wherein the printer prints out an image on the basis of print form data in which information of layout contents of printing elements that form the content of print is set according to the attribute of each printing element, the printing method comprising:
selecting a piece of print form data, which is used for printing, from among multiple pieces of print form data, which are stored in a print form data storage unit that stores the multiple pieces of print form data having different layout contents of the printing elements according to the content of usage, in a specific sequence that is set so that, when the printing is continuously performed, the frequencies of use of the nozzles of the print head are uniform and are equal to or higher than a predetermined frequency;
selecting a piece of printing element data corresponding to each piece of information of layout content that is set in the selected piece of print form data from among multiple types of pieces of printing element data that are stored in a printing element data storage unit that stores the multiple types of pieces of printing element data, which are data of the printing elements, according to the attribute of each printing element; and
inserting the selected piece of printing element data into the selected piece of print form data on the basis of information of the content of print, which is set in the selected piece of print form data.

9. The printer according to claim 1, wherein the specific sequence is one of a descending sequence and an ascending sequence of serial numbers that are associated with the pieces of the print form data and the pieces of printing element data.

10. The printer according to claim 1, wherein the selected piece of printing element data is selected from a same mode as a selection mode set in the printing element data selection unit.
